(19) United States
(12) Patent Application Publication
(10) Pub. No.: US 2018/0330565 A1
(43) Pub. Date: Nov. 15, 2018

(54) AUTOMATED WINE DISPENSING APPARATUS AND MONITORING SYSTEM

(71) Applicant: Wine Plum, Inc., Dania Beach, FL (US)

(72) Inventors: David Koretz, Miami, FL (US); Niculae Mustatea, Sunrise, FL (US); Donald G. Hubbard, Jr., Hollywood, FL (US); Adam Hoydysh, Miami Beach, FL (US); Raul Chinda, Fort Lauderdale, FL (US); Michael Dumont, San Francisco, CA (US)

(21) Appl. No.: 15/766,563

(22) PCT Filed: Oct. 6, 2016
(86) PCT No.: PCT/US2016/055808

§ 371 Date: Apr. 6, 2018

Related U.S. Application Data
(60) Provisional application No. 62/237,978, filed on Oct. 6, 2015.

(51) Int. Cl. G07F 13/02; B67D 1/08; G07F 13/06; G07F 17/00

(52) U.S. Cl. CPC G07F 13/025; B67D 1/0888; G06Q 20/18; G07F 17/0071; B67D 1/0885; G07F 13/065

(57) ABSTRACT

A method, device, and system for in-room wine purchasing and/or dispensing. More specifically, the collaboration of one or more wine dispensing devices, a wine dispensing platform, a property management system, and third-party systems to enable, support, and capitalize on the provision of wine within lodging environments. Mechanisms for enforcing alcohol-related policies and/or regulations maintained by a geographic locality as well as for preventing the consumption of wine by underage or property staff members are also discussed.

### CROSS-REFERENCE TO RELATED APPLICATIONS

This application claims priority under 35 U.S.C. § 119(e) to U.S. Provisional Patent Application Ser. No. 62/237,978, filed on Oct. 6, 2015, which is incorporated herein by reference in its entirety.

### BACKGROUND

The advent of the first major mini-bar deployment in the lodging industry has revolutionized the business model from whence lodgings operate. Guest experiences related to the accessibility of alcoholic beverages within a room, however, suggest improvements in the purchasing and deployment of respective alcoholic beverages are needed.

### SUMMARY

In general, in one aspect of the invention, the invention relates to a method for regulating wine dispensing. The method includes receiving a device specific update (DSU), wherein the DSU specifies at least one location and configuration information, identifying a wine dispensing device (WDD) associated with the at least one specified location, and transmitting the DSU to the WDD.

In general, in one aspect of the invention, the invention relates to a wine dispensing device (WDD). The WDD includes a processing unit, and a touchscreen, wherein the processing unit on the WDD is configured to execute instructions, which enable the WDD to receive a device specific update (DSU) from a Wine Dispensing Platform (WDP), wherein the DSU comprises the configuration information, and apply the configuration information to the WDD.

In general, in one aspect of the invention, the invention relates to a non-transitory computer readable medium (CRM) storing instructions for regulating wine dispensing, the instructions comprising functionality for receiving a device specific update (DSU), wherein the DSU specifies at least one location and configuration information, identifying a wine dispensing device (WDD) associated with the at least one specified location, and transmitting the DSU to the WDD.

Other aspects of the invention will be apparent from the following description and the appended claims.

### BRIEF DESCRIPTION OF DRAWINGS

FIG. 1 shows a diagram of a system in accordance with one or more embodiments of the invention.

FIG. 2 shows a diagram of a wine dispensing platform in accordance with one or more embodiments of the invention.

FIG. 3A shows a diagram of a wine dispensing device in accordance with one or more embodiments of the invention.

FIG. 3B shows an internal drawing of a wine dispensing device in accordance with one or more embodiments of the invention.

FIG. 3C shows an internal drawing of an wine dispensing device in accordance with one or more embodiments of the invention.

FIGS. 4A and 4B show flowcharts describing methods for initializing a wine dispensing device in accordance with one or more embodiments of the invention.

FIGS. 5A and 5B show flowcharts describing methods for updating a wine dispensing device in accordance with one or more embodiments of the invention.

FIG. 6 shows a flowchart describing a method for transmitting an access command in accordance with one or more embodiments of the invention.

FIG. 7A shows a flowchart describing a method for implementing mode transitioning on a wine dispensing device in accordance with one or more embodiments of the invention.

FIGS. 7B and 7C show flowcharts describing methods for interacting with an entity in accordance with one or more embodiments of the invention.

FIGS. 8A and 8B show diagrams of computing systems in accordance with one or more embodiments of the invention.

### DETAILED DESCRIPTION

Specific embodiments of the invention will now be described in detail with reference to the accompanying figures. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In the following description, any component description with regard to a figure, in various embodiments of the invention, may be equivalent to one or more like-named components described with regard to any other figure. For brevity, descriptions of these components will not be repeated with regard to each figure. Thus each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a method, device, and system for in-room wine purchasing and/or dispensing. More specifically, one or more embodiments of the invention include the collaboration of one or more wine dispensing devices, a wine dispensing platform, a property management system, and third-party systems to enable, support, and capitalize on the provision of wine within lodging environments. Mechanisms for enforcing alcohol-related policies and/or regulations maintained by a geographic locality as well as for preventing the consumption of wine by underage or property staff members are also discussed.

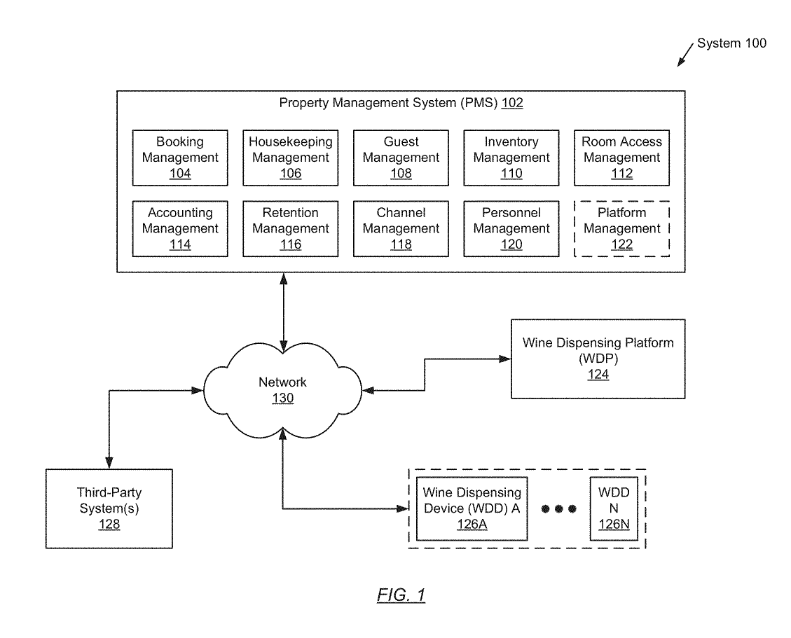

FIG. 1 shows a diagram of a system in accordance with one or more embodiments of the invention. The system (100) includes a property management system (PMS) (102), a wine dispensing platform (WDP) (124), one or more wine dispensing device(s) (WDD) (126A, 126N), one or more third-party system(s) (128), and a network (130). Each of these components is described below.

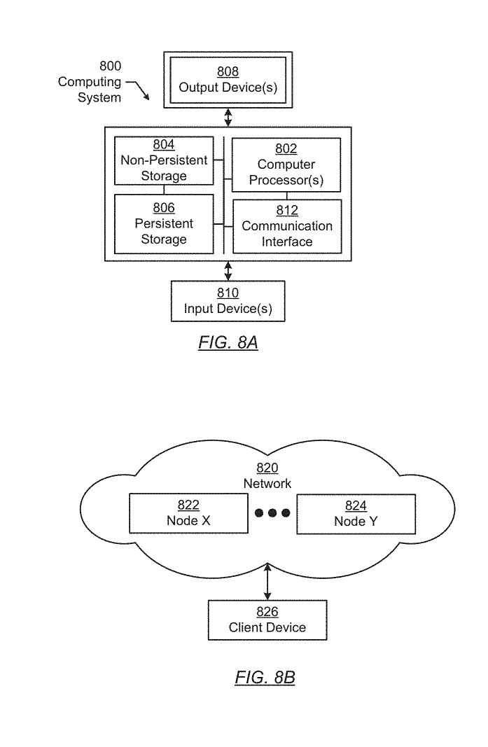

In one embodiment of the invention, the property management system (PMS) (102) may be any of one or more computing system(s) (see e.g., FIGS. 8A and 8B) that include functionality to automate the coordination of day-to-day operations of one or more properties. In one embodiment of the invention, a property may be an establishment that provides lodging accommodations and services. Examples of properties include, but are not limited to, hotels, motels, hostels, bed and breakfasts, inns, etc. Examples of property operations that may be automated by a PMS (102) may include, but are not limited to: guest bookings, online reservations, point of sale (POS), utilities, sales and marketing, food and beverage costing, materials management, personnel management and payroll, maintenance management, and other similar amenities. In one embodiment of the invention, these operations may be subsumed into the responsibilities of various subsystems (described below) managed by a PMS. In another embodiment of the invention, a portion of these subsystems may be managed by the PMS, while another portion of these subsystems may be outsourced to third-party systems (128).

The subsystems may include, but are not limited to, booking management (104), housekeeping management (106), guest management (108), inventory management (110), room access management (112), accounting management (114), retention management (116), channel management (118), personnel management (120), and optionally, platform management (122). Each of these subsystems are described below.

In one embodiment of the invention, the booking management (104) subsystem may be any of one or more computing system(s) (see e.g., FIGS. 8A and 8B) that include functionality to receive and process room reservations at one or more properties. The booking management (104) subsystem may include further functionality to: provide immediate notifications to guests relating to reservation confirmations or cancellations; control and/or anticipate room availability; prevent the overselling of rooms, etc. The booking management (104) subsystem may include other functionalities without departing from the scope of the invention. In one embodiment of the invention, the booking management (104) subsystem may interface with one or more other subsystem(s) (e.g., the guest management (108), accounting management (114), retention management (116), channel management (118), and platform management (122) subsystems) and/or third-party system(s) (128). For example, guest information obtained during the room reservation process may be relayed to the guest management (108) subsystem for consolidation. By way of another example, room reservations captured by outside booking services (e.g., non-property affiliated booking systems) may be relayed from the channel management (118) subsystem, and subsequently, processed.

In one embodiment of the invention, the housekeeping management (106) subsystem may be any of one or more computing system(s) (see e.g., FIGS. 8A and 8B) that include functionality to coordinate and support the responsibilities of the housekeeping staff to clean and maintain the rooms and premises in and around one or more properties. The housekeeping management (106) subsystem may include further functionality to: receive requests for servicing one or more room(s) in their entirety or restocking appliances (e.g., mini-refrigerator, wine dispensing device (WDD), etc.), generate housekeeping schedules, notify housekeeping staff with regards to servicing or restocking requests, etc. The housekeeping management (106) subsystem may include other functionalities without departing from the scope of the invention. In one embodiment of the invention, the housekeeping management (106) subsystem may interface with one or more other subsystem(s) (e.g., the guest management (108), inventory management (110), room access management (112), personnel management (120), and platform management (122) subsystems) and/or third-party system(s) (128). For example, requisitions may be relayed to, and responses subsequently received from, the inventory management (110) subsystem. The requisitions may relate to the determination of available, or the procurement of additional, supplies and/or products used or stocked by housekeeping staff.

In one embodiment of the invention, the above-mentioned housekeeping schedules may include servicing hours set for any given WDD. In such an embodiment, users of the PMS (102) may be able to coordinate the servicing of WDDs to coincide with status information obtained from one or more WDD(s) (126A, 126N) via the WDP (124). For example, real-time (or near real-time) status information (e.g., wine levels, inert gas levels, etc.) associated with a given WDD (126A, 126N) may be logged and reported to the PMS (102) via the WDP (124). Subsequently, servicing hours for the WDD (126A, 126N) may be dynamically scheduled based on whether it is determined that wine packages need replacement, or maintenance needs to be performed. The servicing hours schedule may be based on local alcohol-related policies. For example, consider a scenario in which a hotel is located in a jurisdiction in which no alcohol can be served on Sundays. In such scenarios, if a hotel guest attempts to request (e.g., via the touchscreen on the WDD) a new bottle of wine at 12:01 am on Sunday, that the servicing hours (which are programmed into the WDD or into the WDP) would prohibit a request from being sent from the WDD or the WDP to the housekeeping management system.

In one embodiment of the invention, the guest management (108) subsystem may be any of one or more computing system(s) (see e.g., FIGS. 8A and 8B) that include functionality to track and/or consolidate guest pertinent information. Subsequently, the guest management (108) subsystem may include further functionality to: generate, modify, and/or store guest profiles and preferences; maintain guest histories (e.g., bookings, invoices, requests, etc. per guest), generate correspondences to guests, etc. The guest management (108) subsystem may include other functionalities without departing from the scope of the invention. In one embodiment of the invention, the guest management (108) subsystem may interface with one or more other subsystem(s) (e.g., the booking management (104), housekeeping management (106), accounting management (114), and retention management (116) subsystems) and/or third-party system(s) (128). For example, guest preferences regarding room preparations may be relayed to the housekeeping management (106) subsystem. By way of another example, guest histories may be relayed to the retention management (116) subsystem, which may subsequently use the guest histories to generate and convey promotions, special room rates, etc., to qualifying guests. In another example, the guest profile may include a code (or other notation) which indicates that the guest is a member of a hotel awards and/or loyalty program. In another example, the guest profile may indicate that the guest is part of a specific group of individuals staying at the hotel. For example, the guest may be staying at the hotel in a block of rooms reserved for a wedding, a corporate event, a conference, or any other event.

In one embodiment of the invention, the inventory management (110) subsystem may be any of one or more computing system(s) (see e.g., FIGS. 8A and 8B) that include functionality to track or monitor the levels of supplies, products, etc., available at one or more properties. The inventory management (110) subsystem may include further functionality to: optimize or automate the reordering of supplies, products, etc., when levels reach a specified threshold; receive requests or searches inquiring about inventory levels; log and track tangible assets (e.g., vehicles, equipment, wine dispensing devices (WDD), etc.), etc. The inventory management (110) subsystem may include other functionalities without departing from the scope of the invention. In one embodiment of the invention, the inventory management (110) subsystem may interface with one or more other subsystem(s) (e.g., the housekeeping management (106), accounting management (114), and platform management (122) subsystems) and/or third-party system(s) (128). For example, as mentioned above, inquiries may be received from the housekeeping management (106) subsystem to ascertain supply and/or product inventory levels. By way of another example, purchasing receipts may be relayed to the accounting management (114) subsystem for logging.

In one embodiment of the invention, the room access management (112) subsystem may be any of one or more computing system(s) (see e.g., FIGS. 8A and 8B) that include functionality to authorize and track the accessing of various rooms at one or more properties. The room access management (112) subsystem may include further functionality to: encode any supported electronic medium (e.g., a magnetic strip embedded key card, a radio frequency (RF) ID key card or fob, etc.) with authorization codes to facilitate room entry, log the usage of which electronic mediums to gain entry to which rooms, generate notifications or reports highlighting these room access entries (RAE), etc. The room access management (112) subsystem may include other functionalities without departing from the scope of the invention. In one embodiment of the invention, the room access management (112) subsystem may interface with one or more other subsystem(s) (e.g., the personnel management (120) and platform management (122) subsystems) and/or third-party system(s) (128). For example, RAEs may be relayed to the platform management (122) subsystem, which may use the RAEs to assess to which operating mode a respective WDD transitions (discussed below).

In one embodiment of the invention, the accounting management (114) subsystem may be any of one or more computing system(s) (see e.g., FIGS. 8A and 8B) that include functionality to record and process financial transactions involving one or more properties. Subsequently, the accounting management (114) subsystem may include further functionality to: perform analyses using transaction data associated with the financial transactions; generate reports based on the aforementioned analyses; generate invoices, payroll checks, or other finance-related documentation; monitor and manage property-owned accounts at financial institutions, etc. The accounting management (114) subsystem may include other functionalities without departing from the scope of the invention. In one embodiment of the invention, the accounting management (114) subsystem may interface with one or more other subsystem(s) (e.g., the booking management (104), guest management (108), inventory management (110), retention management (116), channel management (118), personnel management (120), and platform management (122) subsystems) and/or third-party system(s) (128). For example, payment related information for the reservation of rooms may be relayed from the booking management (104) subsystem. By way of another example, invoices for services rendered by online travel agents (OTA) may be relayed from the channel management (118) subsystem for subsequent processing and payment.

In one embodiment of the invention, the retention management (116) subsystem may be any of one or more computing system(s) (see e.g., FIGS. 8A and 8B) that include functionality to scheme and improve guest retention and experience at one or more properties. The retention management (116) subsystem may include further functionality to: aggregate and analyze guest experience data, generate and publish promotional offers, special room rates, and discounted or comped services and products, and other incentives, derive eligibility guidelines or rules, process the redemption of award points or similar currency, etc. The retention management (116) subsystem may include other functionalities without departing from the scope of the invention. In one embodiment of the invention, the retention management (116) subsystem may interface with one or more other subsystem(s) (e.g., the booking management (104), guest management (108), accounting management (114), and platform management (122) subsystems) and/or third-party system(s) (128). For example, promotional codes may be relayed to the guest management (108) subsystem, which may append the codes to generated correspondences addressed to eligible guests. By way of an another example, vouchers or coupons entered during the room reservation process may be relayed from the booking management (104) subsystem to the retention management (116) subsystem, which may subsequently relay back the appropriate benefits awarded.

In one embodiment of the invention, the channel management (118) subsystem may be any of one or more computing system(s) (see e.g., FIGS. 8A and 8B) that include functionality to control property exposure and reputation. Thus, the channel management (118) subsystem may include further functionality to: develop marketing and public relations campaigns, coordinate with third-party global distribution systems (GDS) and online travel agents (OTA) towards maximizing room reservations, etc. The channel management (118) subsystem may include other functionalities without departing from the scope of the invention. In one embodiment of the invention, the channel management (118) subsystem may interface with one or more other subsystem(s) (e.g., the booking management (104), accounting management (114), and retention management (116) subsystems) and/or third-party system(s) (128) (e.g., GDS and OTA). For example, as mentioned above, reservations captured by third-party systems (128) may be relayed to the booking management (104) subsystem for subsequent processing and recording.

In one embodiment of the invention, the personnel management (120) subsystem may be any of one or more computing system(s) (see e.g., FIGS. 8A and 8B) that include functionality to track and/or consolidate staff pertinent information. The personnel management (120) subsystem may include further functionality to: generate, modify, and/or store staff profiles, provide resources for staff at one or more properties, devise strategies for employment analysis, planning, recruitment, and selection, oversee staff authorizations and restrictions, etc. The personnel management (120) subsystem may include other functionalities without departing from the scope of the invention. In one embodiment of the invention, the personnel management (120) subsystem may interface with one or more other subsystem(s) (e.g., the room access management (112) and accounting management (114) subsystems) and/or third-party system(s) (128). By way of an example, electronic mediums (mentioned above) encoded with appropriate authorizations may be generated by the room access management (112) subsystem given access-related staff information relayed by the personnel management (120) subsystem.

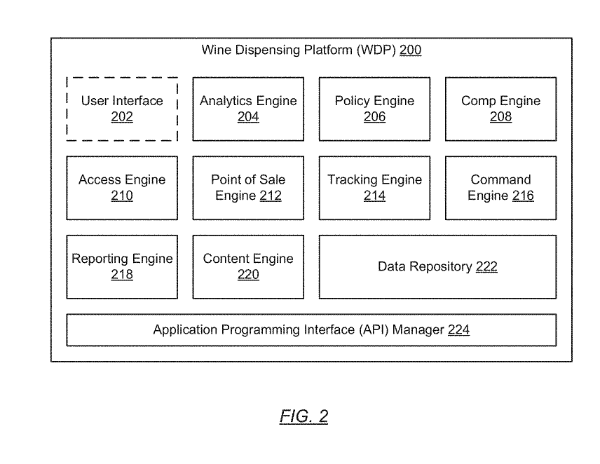

In one embodiment of the invention, the platform management (122) subsystem may be any of one or more computing system(s) (see e.g., FIGS. 8A and 8B) that include functionality to utilize the WDP (124) towards controlling and monitoring one or more WDDs (126A, 126N) at one or more properties. Subsequently, the platform management (122) subsystem may include further functionality to harness the features and/or engines provided by the WDP (124), which is discussed in further detail below with respect to FIG. 2. In one embodiment of the invention, the platform management (122) subsystem may be an application programming interface (API) directed to the user interface of the WDP (124). In one embodiment of the invention, an API may include a set of routines, protocols, and tools that include functionality to enable and facilitate the interfacing with a backend service and/or resources. In one embodiment of the invention, the users of the PMS may be able to obtain all or a portion of the analytics information (or any other information related to the WDDs) that is stored on the WDP via the platform management subsystem (122).

One of ordinary skill will appreciate that the PMS (102) may include additional or alternative subsystems without departing from the scope of the invention.

In one embodiment of the invention, the wine dispensing platform (WDP) (124) may be a hardware and/or software implemented service that provides the centralized management of one or more wine dispensing device(s) (WDD) (126A, 126N). The WDP (124) may be hosted on a physical server (e.g., in a data center, or on a virtual server that may be cloud-based). The WDP (124) may be hosted on a single server, or alternatively, on multiple servers that are physical, virtual, or a combination thereof. In one embodiment of the invention, the WDP (124) may be hosted on any of one or more computing system(s) similar to the exemplary computing systems shown in FIGS. 8A and 8B.

In one embodiment of the invention, the WDP (124) may include functionality to: (i) track and consolidate status information pertaining to one or more WDD(s) (126A, 126N); (ii) maintain room-device mappings relating room identifiers to WDDs (126A, 126N); (iii) track wine inventory at one or more properties, (iv) push configurations (e.g., device specific initializations (DSI)), updates (e.g., device specific updates (DSU)), and/or commands (e.g., access commands) to one or more WDD(s) (126A, 126N), (v) perform analyses on status, financial, consumption, etc., information associated with one or more WDD(s) (126A, 126N), and subsequently, (vi) generate and provide reports using at least the obtained analytic information. The WDP (124) is discussed in further detail below with respect to FIG. 2.

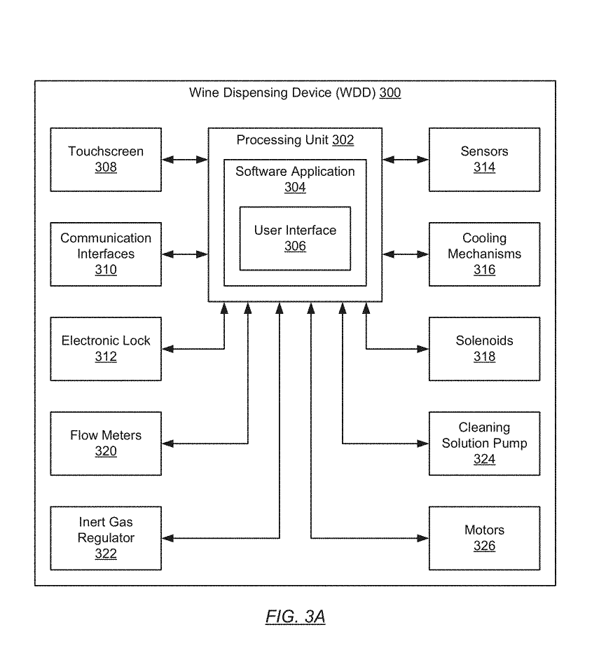

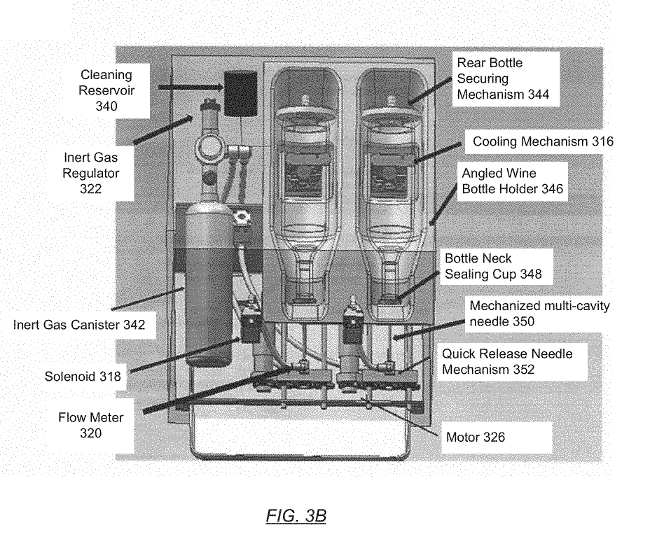

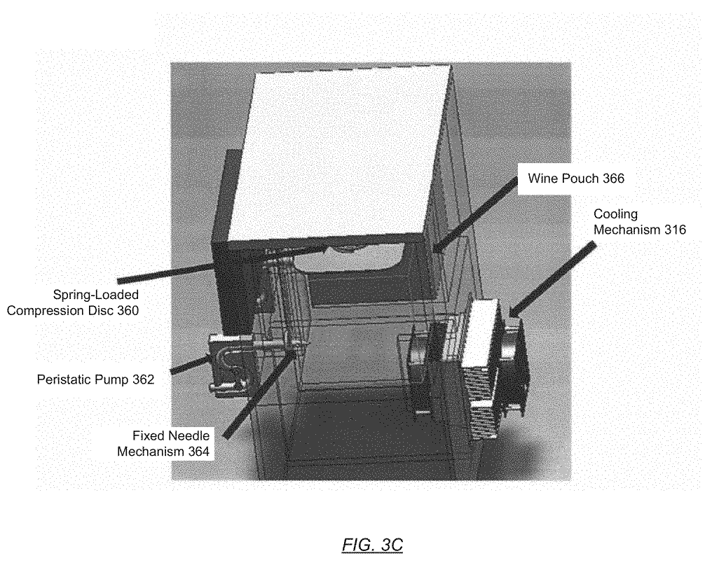

In one embodiment of the invention, a wine dispensing device (WDD) (126A, 126N) may be a physical device through which wine may be purchased or comped and thus dispensed. In one embodiment of the invention, the WDD (126A, 126N) may be implemented as any computing system similar to the exemplary computing systems shown in FIGS. 8A and 8B. The WDD (126A, 126N) may include functionality to: (i) request configuration information (e.g., DSI) from the WDP (124), (ii) obtain configuration information, updates, and/or commands from the WDP (124), (iii) transition to and operate at different modes triggered by the entity (e.g., property staff member or guest) associated with a logged room access entry (RAE), (iv) track and share status information with the WDP (124), and (v) generate and relay notifications and/or reports to one or more property management system (PMS) (102) subsystem(s) (e.g., the housekeeping management (106), inventory management (110), and accounting management (114) subsystems). The WDD (126A, 126N) is discussed in further detail below with respect to FIGS. 3A-3C.

In one embodiment of the invention, a third-party system (128) may be a provider of resources and/or services employed by/at one or more properties. A resource and/or service provider may include, but is not limited to, a global distribution system (GDS), an online travel agent (OTA), and an alcohol policy information system (APIS). In one embodiment of the invention, a GDS or an OTA may include functionality to: provide and/or automate travel-related transactions, offer worldwide exposure of one or more properties, interface with the channel management (118) subsystem of the PMS (102), drive room reservations, etc. Examples of a GDS include, but are not limited to, Amadeus, Galileo, Sabre, and Worldspan. Examples of an OTA include, but are not limited to, Hotwire, Priceline, Expedia, and Orbitz. In one embodiment of the invention, an APIS may include functionality to: provide detailed information on a variety of alcohol-related policies and/or regulations within any geographical granularity, provide informational resources regarding alcohol policy related research and issues; interface with the WDP (124), etc. An example of an APIS includes, but is not limited to, the Alcohol Policy Information System sponsored by the National Institute on Alcohol Abuse and Alcoholism. GDSs, OTAs, and APISs may include additional or alternative functionalities without departing from the scope of the invention. Further, other third-party systems may be employed without departing from the scope of the invention.

In one embodiment of the invention, a third-party system (128) may be hosted on a physical server (e.g., a data center, or on a virtual server that may be cloud-based). The third-party system (128) may be hosted on a single server, or alternatively, on multiple servers that are physical, virtual, or a combination thereof. In one embodiment of the invention, the third-party system (128) may be hosted on any of one or more computing system(s) similar to the exemplary computing systems shown in FIGS. 8A and 8B.

In one embodiment of the invention, the network (130) may be the medium through which the PMS (102), the WDP (124), the one or more WDD (126A, 126N), and the third-party system(s) (128) are operatively connected. The connections between these aforementioned components may be wired and/or wireless, direct or indirect, temporary, permanent and/or intermittent, through a local area or wide area network, or include any other type of connection, or combination thereof. Further, the network (130) may employ any existing or future developed wired and/or wireless infrastructure and/or protocols, which may facilitate communications and/or the exchange of information between the various components of the system (100).

FIG. 2 shows a diagram of a wine dispensing platform in accordance with one or more embodiments of the invention. As mentioned above, in one embodiment of the invention, the WDP (200) may oversee management of one or more WDD(s). To that end, the WDP (200) includes a user interface (202) (optionally), an analytics engine (204), a policy engine (206), a comp engine (208), an access engine (210), a point of sale (POS) engine (212), a tracking engine (214), a command engine (216), a reporting engine (218), a content engine (220), a data repository (222), and an application programming interface (API) manager (224). Each of these components is described below.

In one embodiment of the technology, the WDP receives, via either a push mechanism or a pull mechanism, real-time (or near real-time) information about the status of each WDD to which it is connected. The status information that is received from the WDDs is then used by one or more of the components listed below.

In one embodiment of the invention, the user interface (202) may include software instructions corresponding to computer readable program code executing on the underlying hardware (e.g., one or more integrated circuit(s)) of the WDP (200). Further, when executed, the software instructions may bestow upon the user interface (202) the functionality to: (i) present, to users with which the WDP (200) interacts, status, financial, consumption, analytic, etc., information concerning one or more WDD(s), (ii) obtain, from users with which the WDP (200) interacts, input and/or commands; and (iii) delegate, to one or more engines of the WDP (200), tasks based on the obtained inputs and/or commands.

In one embodiment of the invention, the analytics engine (204) may include software instructions corresponding to computer readable program code executing on the underlying hardware (e.g., one or more integrated circuit(s)) of the WDP (200). Further, when executed, the software instructions may bestow upon the analytics engine (204) the functionality to: (i) perform analyses on consolidated information (e.g., status, historical, consumption, financial information, etc.) pertaining to one or more WDD(s); (ii) derive analytic information (e.g., wine consumption metrics, wine restocking and replacement forecasting, revenue summaries, wine consumption to guest/population demographic correlations, etc.) using the consolidated information, and (iii) interface with at least the guest management subsystem of the PMS to share guest specific or related analytic information.

In one embodiment of the invention, the analytics engine (204) may include further functionality to enable the A:B testing of various pricing and promotion models. In such an embodiment, A:B testing may involve the advertising and comparison of two different pricing (or promotion) offers to determine which offer performs better. In such an embodiment, the results of A:B testing may be used in order to maximize revenue from the dispensing of wine. In another embodiment of the invention, the analytics engine (204) may support the testing of various marketing campaigns and their effectiveness on stimulating wine purchases. In such an embodiment, the various marketing campaigns in the form of different interactive content may be projected to guests via a touchscreen of a WDD. Subsequently, correlations between the loaded interactive content and the sale/dispensing of wine may be computed. In one embodiment of the invention, the analytics engine (204) may include further functionality to make real-time changes to pricing information or marketing campaigns, thereby optimizing purchase behavior and revenue.

In one embodiment of the invention, the policy engine (206) may include software instructions corresponding to computer readable program code executing on the underlying hardware (e.g., one or more integrated circuit(s)) of the WDP (200). Further, when executed, the software instructions may bestow upon the policy engine (206) the functionality to: (i) interface with one or more alcohol policy information system(s) (APIS) (discussed above); (ii) obtain, from the one or more APIS, detailed information regarding alcohol-related policies and/or regulations enforced at the geographic areas the one or more wine dispensing device(s) (WDD) are deployed, and (iii) collaborate with the command engine (216) to impose restrictions affecting the purchase and/or dispensing of wine based at least on the obtained detailed information.

In one embodiment of the invention, the comp engine (208) may include software instructions corresponding to computer readable program code executing on the underlying hardware (e.g., one or more integrated circuit(s)) of the WDP (200). Further, when executed, the software instructions enable the comp engine (208) to: (i) track the awarding and usage of comps (or free pours) to/at each WDD within one or more properties; (ii) track under which type each free pour is associated (e.g., services recovery, online travel agent (OTA) recovery, rewards/loyalty program, virtual amenities, etc.), and (iii) interface with at least the retention management subsystem of the PMS to receive issued comps and subsequently report on the use of issued comps. In one embodiment of the invention, if a guest is provided a number of complementary glasses of wine and the guest does not drink all of the complementary glasses of wine prior to checking out of the hotel/property, then the PMS may remove any used complementary glasses of wine from the guest profile. The PMS uses the information tracked by the comp engine (208) (i.e., how many complementary glasses of wine dispensed by the WDD to the guest) in order to update the guest profile to remove any unused complementary glasses of wine.

For example, if the guest is given give complementary glasses of wine and only dispenses two complementary glasses of wine, then upon checkout, the PMS may obtain the aforementioned consumption information from the WPD and then reclaim/remove the remaining three unconsumed complementary glasses of wine from the guest's profile.

In one embodiment of the invention, the access engine (210) may include software instructions corresponding to computer readable program code executing on the underlying hardware (e.g., one or more integrated circuit(s)) of the WDP (200). Further, when executed, the software instructions may bestow upon the access engine (210) the functionality to: (i) obtain room access entries (RAE) (discussed below), (ii) process RAEs in conjunction with room-device mappings to identify the WDDs to which the RAEs are associated, (iii) collaborate with the command engine (216) to generate access commands based on the RAEs, and (iv) interface with at least the room access management subsystem of the PMS from which the RAEs is obtained.

In one embodiment of the invention, the POS engine (212) may include software instructions corresponding to computer readable program code executing on the underlying hardware (e.g., one or more integrated circuit(s)) of the WDP (200). Further, when executed, the software instructions may bestow upon the POS engine (212) the functionality to: (i) facilitate and process the sale/purchase of wine at each WDD on one or more properties, (ii) track and temporarily or permanently store the resulting financial transactions, (iii) provide or collaborate with a third-party system to provide financial data security and/or encryption, and (iv) interface with at least the accounting management and guest management subsystems of the PMS to share transaction data corresponding to the resulting financial transactions and record guest payment-related information, respectively.

In one embodiment of the invention, the tracking engine (214) may include software instructions corresponding to computer readable program code executing on the underlying hardware (e.g., one or more integrated circuit(s)) of the WDP (200). Further, when executed, the software instructions enables the tracking engine (214) to perform one or more of the following: (i) monitor the status (e.g., real-time (or near real-time) tracking of the levels of wine and inert gas remaining) of each WDD on one or more properties, (ii) maintain the room-device mappings relating which room a WDD is associated, and vice versa, (iii) track the wine inventory at one or more properties, (iv) track and consolidate the current configuration parameters and/or settings enacted at each WDD on one or more properties, and (v) interface with at least the inventory management subsystem of the PMS to track inventory levels pertaining to wine at the one or more premises.

In one embodiment of the invention, the command engine (216) may include software instructions corresponding to computer readable program code executing on the underlying hardware (e.g., one or more integrated circuit(s)) of the WDP (200). Further, when executed, the software instructions may bestow upon the command engine (216) the functionality to: (i) generate or obtain device specific initializations (DSI), device specific updates (DSU), and/or access commands (discussed below), (ii) collaborate with one or more other engines (e.g., policy engine (206), access engine (210), etc.) to obtain and/or integrate information pertinent to the generation of the items listed in (i), (iii) generally oversee the operations and allocation of resources on the WDP (200), and (iv) engage with communication interfaces (not shown) on the WDP (200) to effectively transmit and/or receive information to/from one or more WDD(s).

In one embodiment of the invention, the reporting engine (218) may include software instructions corresponding to computer readable program code executing on the underlying hardware (e.g., one or more integrated circuit(s)) of the WDP (200). Further, when executed, the software instructions enable the reporting engine (218) to: (i) generate reports based on information provided by the one or more WDD(s), (ii) issue notifications requesting the replacement of wine packages (e.g., bottle or pouch) or inert gas canisters on appropriate WDDs, (iii) issue notifications requesting the performance of maintenance on appropriate WDDs, (iv) collaborate with one or more other engines (e.g., analytic engine (204), comp engine (208), POS engine (212), tracking engine (214), etc.) to obtain and integrate respective information pertinent to the generation of the types of reports listed in (i), and (v) interface with at least the housekeeping management subsystem of the PMS to which the issued notifications are addressed.

In one embodiment of the invention, the real-time (or near real-time) information obtained from the WDDs may be used to determine which of the WDDs may require serving or maintenance. For example, the reporting engine (218) may analyze the consumption information received from the various WDDs and generate a service list that only specifies a set of WDDs that required the housekeeping staff to refill/change out empty wine bottles. The determination of whether a WDD needs to be refilled may be based on, for example, whether the current wine level in the WDD is below a threshold wine level. The aforementioned determination may also take into account the consumption rate. In such cases, the WDD may need to be serviced if the consumption rate is above a certain level even though the wine level is not below a threshold wine level. The generation of such a list using real-time (or near-real time) information from the WDDs enables efficient utilization of hotel resources while at the same time not degrading any guest experience due to improperly stocked/under stocked WDDs.

In one embodiment of the invention, the content engine (220) may include software instructions corresponding to computer readable program code executing on the underlying hardware (e.g., one or more integrated circuit(s)) of the WDP (200). Further, when executed, the software instructions may bestow upon the content engine (220) the functionality to: (i) manage and/or generate the interactive content (e.g., text, images, videos, audio, etc.) with which wine purchasing is compelled on one or more WDD(s), and (ii) manage and/or generate the descriptive details with which a particular wine is associated.

In one embodiment of the invention, the data repository (222) may be any type of storage unit and/or device (e.g., a file system, database, collection of tables, or any other storage medium) for storing data relating to the management of one or more WDD(s). Further, the data repository (222) may include multiple different storage units and/or devices. The multiple different storage units and/or devices may or may not be of the same type or located at the same physical site. In one embodiment of the invention, the data stored in the data repository (222) may relate to: (i) the room-device mappings (discussed below), (ii) status, consumption, financial, etc. data obtained from each WDD, (iii) analytic information derived from the performance of analyses on any data stored in the data repository (222), (iv) interactive content (e.g., text, images, videos, audio, etc.) generated and provided to one or more WDD(s) for presentation via their respective touchscreens, (v) detailed information describing the characteristics, origins, etc. of dispensed wine varieties, and (vi) software instructions corresponding to computer readable program code, which enable the WDP (200) to perform embodiments of the invention.

In one embodiment of the invention, the API manager (224) may include hardware, software, firmware, or any combination thereof, which may include functionality to consolidate the set of APIs utilized by the WDP (200). In one embodiment of the invention, an API may be a set of routines, protocols, and/or tools that may be employed in order to facilitate interfacing with one or more subsystems of the PMS or third-party systems. The API manager (224) may include further functionality to create support resources entailing the definition and documentation of the consolidated set of APIs.

FIG. 3A shows a diagram of a wine dispensing device in accordance with one or more embodiments of the invention. The WDD (300) includes a processing unit (302), a touchscreen (308), one or more communication interfaces (310), an electronic lock (312), one or more sensors (314), one or more cooling mechanisms (316), one or more solenoids (318), one or more flow meters (320), an inert gas regulator (322), a cleaning solution pump (324), and one or more motors (326). Each of these components is described below.

In one embodiment of the invention, the processing unit (302) may constitute one or more integrated circuit(s) for processing instructions. For example, the processing unit (302) may include one or more cores, or micro-cores of a computer processor. Additionally, or alternatively, the processing unit (302) may be implemented using an application specific integrated circuit (ASIC), a field programmable gate array (FPGA), a graphics processing unit (GPA), a microcontroller, a discrete processor, a digital signal processor (DSP), or any other type of integrated circuit, or any combination thereof. In one embodiment of the invention, the instructions processed by the processing unit (302) may correspond to computer readable program code, which when executed, enable the processing unit (302) to manage the operations and components of the WDD (300). To that end, the processing unit (302) may be operatively (i.e., directly or indirectly) connected to each of the aforementioned components of the WDD (300).

In one embodiment of the invention, at least a portion of the software instructions processed by the processing unit (302) relates to the instantiation of a software application (304). A software application (304) may be any computer program product that may enable an interacting user to engage with the features of the WDD (300) (discussed below). The term software application may include different versions and/or editions of the same software application. The software application (304) may include further functionality to generate a user interface (306) and manage interface-related processes. In one embodiment of the invention, the user interface (306) may be a graphical user interface (GUI) through which interactive content (e.g., text, images, videos, etc.) and controls (e.g., list boxes, pop-up menus, push buttons, sliders, checkboxes, icons, etc.) may be provided. Manipulation of the interactive content and/or controls, by an interacting user, may subsequently trigger the processing unit (302) to perform embodiments of the invention in collaboration with one or more other component(s) of the WDD (300) and/or the wine dispensing platform (WDP).

In one embodiment of the invention, the touchscreen (308) may be a touch-sensitive display screen operatively connected to the processing unit (302). The touchscreen (308) is both an output and input device. As an output device, the touchscreen (308) may include functionality to render graphical elements (e.g., the interactive content and/or controls) of the user interface (306) for presentation to the interacting user. In one embodiment of the invention, interactive content conveyed by the touchscreen (308) may include, but is not limited to, marketing messages and videos purposed for compelling the purchase of wine, informative text and images purposed for describing the wine(s) enclosed within the WDD (300), etc. As an input device, the touchscreen (308) may include functionality to detect the manipulation or engagement of graphical elements by the interacting user. Upon detecting and identifying which graphical element was engaged, the touchscreen (308) may relay the findings to the processing unit (302), which may subsequently execute software instructions associated with the identified graphical element that perform one or more embodiments of the invention. Examples of a touchscreen may include, but are not limited to, resistive touchscreens, surface acoustic wave (SAW) touchscreens, capacitive touchscreens, light beam touchscreens, infrared grid touchscreens, etc. The WDD (300) may be implemented using a screen that is not touch enabled without departing from the invention.

In one embodiment of the invention, a communication interface (310) may include hardware, software, firmware, or any combination thereof, which enables and facilitates the exchange of information between the WDD (300), the wine dispensing platform (WDP), and/or other portable or non-portable computing systems (e.g., a mobile device belonging to a guest, etc.). The communication interface(s) (310) may be operatively connected to the processing unit (302). In one embodiment of the invention, the communication interface(s) (310) may include functionality to: (i) transmit, via a wired and/or wireless medium/protocol, status, consumption, financial, descriptive, etc., information to the WDP and/or other computing systems; and (ii) receive, via a wired and/or wireless medium/protocol, configuration, update, command, authorization, payment, etc. information from the WDP and/or other computing systems. For example, a Bluetooth transceiver may be integrated to enable guests to connect their mobile computing systems (e.g., smartphones, tablets, etc.) to the WDD (300) for the purpose of sharing descriptive or support information pertaining to the WDD (300), the wines, etc. By way of another example, a near-field communication (NFC) reader may be employed in order to offer guests alternate mechanisms relating to payment (e.g., Apple Pay, Android Pay, etc.). Other examples of communication interface(s) (310) include, but are not limited to, a network interface controller/device, a network socket, an antenna, etc.

In one embodiment of the invention, the electronic lock (312) may be a remotely monitored and controlled locking device that includes functionality to prevent access to the interior of the WDD (300) without proper authorization. Employment of the electronic lock (312) may subsequently prevent tampering and/or damaging of the internal mechanisms of the WDD (300) by curious guests, and theft of the enclosed wine. In one embodiment of the invention, the electronic lock (312) may be actuated through the supplying or removing of power to/from one or more electro-magnets (not shown), solenoids (318), motors (326), or any combination thereof. In one embodiment of the invention, the electronic lock (312) may incorporate a radio frequency identification (RFID) sensor (314), which includes functionality to permit property staff to unlock the WDD (300) electronically with a master electronic medium (e.g., key card, tag, fob, etc.).

In one embodiment of the invention, a sensor (314) may include hardware, software, firmware, or any combination thereof, which detects and measures one or more physical properties (e.g., heat, light, sound, pressure, motion, etc.). Sensor(s) (314) may include functionality to encode these aforementioned measurements into analog and/or digital signals (or data) that may be interpreted and/or processed by the processing unit (302) (to which the sensor(s) (314) are operatively connected). In one embodiment of the invention, sensor(s) (314) included in the WDD (300) include, but are not limited to, an RFID sensor (mentioned above), a proximity sensor, a front-facing camera, flow meters (320) (discussed below), etc. In one embodiment of the invention, a proximity sensor may include functionality to detect the presence or absence of containers under a wine pouring spout, or interacting users near the WDD (300). In one embodiment of the invention, the enablement or disablement of the pouring of wine, thereby preventing spillage, may be triggered based a container for the wine is present or absent.

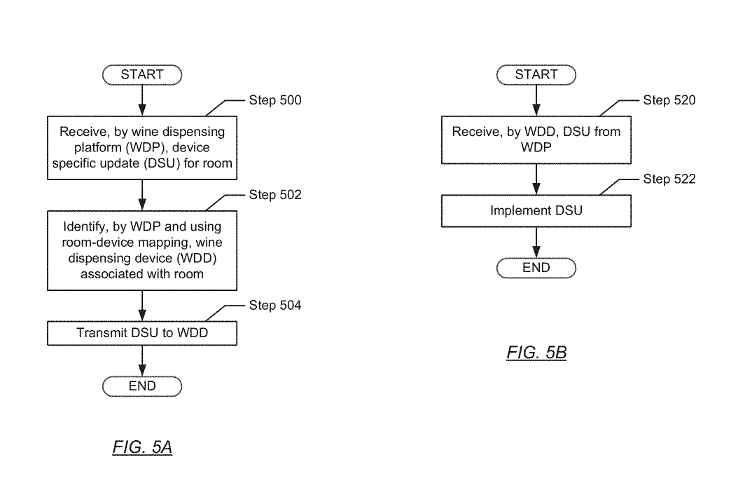

In one embodiment of the invention, the touchscreen (308) may automatically switch on or off, based on input from the proximity sensor, depending on whether an interacting user is nearby or not. When switched on, the touchscreen may display one or more messages to users. For example, consider a scenario in which a user checks into a hotel. In response to checking in to the hotel, the property management system detects, based on the user's profile, that the user is a member of an awards program. Based on this determination, the property management system generates (either automatically or with input from a hotel staff member) a message to be displayed to the user via the touchscreen. This message is subsequently provided to the WDD (330), for example, via the methods shown in FIGS. 5A and 5B. When the user enters the room and is near the WDD (300), the proximity sensor may detect the presence of the user and automatically switch on the touchscreen to display the message to the user.

In one embodiment of the invention, a front-facing camera may include functionality to provide guests with a mechanism through which payment information associated with, for example, a credit card, may be captured and processed for the purchase of wine. The front-facing camera thus provides an alternative method for obtaining payment information, which alleviates the necessity for guests to manual enter the payment information through the user interface (306).

In one embodiment of the invention, a cooling mechanism (316) may include hardware, software, firmware, or any combination thereof, which may include the functionality to maintain the enclosed wine(s) or internal components at appropriate temperature ranges. With respect to the enclosed wines, the cooling mechanism(s) (316) may provide refrigeration, thereby enabling the wines to be poured or consumed at specified serving temperatures. These specified serving temperatures may be designated by the PMS and/or the WDP. In one embodiment of the invention, the cooling mechanism(s) (316) may be utilized to prevent the overheating of one or component(s) (e.g., the processing unit (302)) of the WDD (300). Examples of a cooling mechanism include, but are not limited to, a solid state cooling system, a thermoelectric chiller, an air cooling fan, a water cooling system, etc.

In one embodiment of the invention, a solenoid (318) may be a coiled wire assembly, which when carrying an electric current, functions as a magnet. Solenoids (318) may include further functionality to operate as an electronic switch or relay that controls the actuation of a mechanical component/device. In one embodiment of the invention, a solenoid (318) may be employed to actuate and/or facilitate the extraction of wine from one or more types of wine packages (e.g., wine bottle, wine pouch, etc.).

In one embodiment of the invention, a flow meter (320) may be an instrument or a sensor that includes functionality to measure the volume, pressure, and/or volumetric rate associated with a fluid flow. As such, a flow meter (320) may be used to obtain at least these aforementioned measurements when dispensing wine from the WDD (300). Examples of a flow meter include, but are not limited to, mechanical flow meters, pressure-based flow meters, optical flow meters, electromagnetic flow meters, etc.

In one embodiment of the invention, the inert gas regulator (322) may be a valve that manages the release of inert gas from the inert gas canister (see e.g., FIG. 3B). The inert gas regulator (322) may include further functionality to allow the highly pressured inert gas contained within the inert gas canister to be reduced to safe and usable pressures. To that end, the inert gas regulator (322) operates by utilizing a measuring element (not shown) to determine and match the flow of inert gas through the valve to the load demand (e.g., demand for inert gas placed upon by the WDD (300)).

In one embodiment of the invention, the cleaning solution pump (324) may be a mechanism or device that include functionality to circulate a water and cleaning solution mix through the wine tubing and needle mechanisms (see e.g., FIG. 3B). The cleaning solution pump (324) may be attached to a cleaning solution reservoir, and may subsequently operate by: (i) extracting the water and cleaning solution mix from the cleaning solution reservoir; and (ii) driving the extracting mix through the wine tubing and needle mechanisms. In one embodiment of the invention, the cleaning solution pump (324) may serve to automate the cleaning of the aforementioned components of the WDD (300).

In one embodiment of the invention, a motor (326) may be an electrical, piezoelectric, electro-mechanical, mechanical, or hydraulic device, or any combination thereof, which actuates an otherwise static component. In one embodiment of the invention, a motor (326) may be used to actuate a mechanized multi-cavity needle (see e.g., FIG. 3B), thereby enabling the aforementioned needle to penetrate a wine cork or closure.

FIGS. 3B and 3C show internal drawings of a wine dispensing device in accordance with one or more embodiments of the invention. Specifically, FIG. 3B shows an internal drawing incorporating wine bottles, whereas FIG. 3C shows an internal drawing incorporating alternative packaging, such as wine pouches. The wine dispensing device is not limited to the embodiments shown in FIGS. 3B and 3C.

Turning to FIG. 3B, in one embodiment of the invention, a wine dispensing device (WDD) may include a cleaning reservoir (340). The cleaning reservoir (340) may include functionality to contain water and cleaning solution necessary to automate the cleaning of the wine tubing and mechanized multi-cavity needles (350) periodically. In cleaning these components automatically, the manual labor and/or costs associated with maintaining the WDD are reduced. In one embodiment of the invention, a WDD may further include an inert gas canister (342). Injection of inert gas within a bottle of wine may be employed to pressurize the bottle and/or preserve the wine within the bottle for a prolonged duration of time. Examples of inert gas that may be used include, but are not limited to, argon and nitrogen. In one embodiment of the invention, rear bottle securing mechanisms (344) may be employed to attach to the punt of the wine bottles. Subsequently, the rear bottle securing mechanisms (344) may move the wine bottle towards the mechanized multi-cavity needle (350), where the mechanized multi-cavity needle (350) is spinning. Further, the spinning motion produced may reduce the downward force on the wine cork or closure, thus preventing the mechanized multi-cavity needle (350) from pushing the cork into the wine bottle.

In one embodiment of the invention, a WDD may further include angled wine bottle holders (346), which situate the enclosed wine bottles at an angled position. Angling of the wine bottles, in conjunction with gravity, may enable the flow of wine with reduced necessary pressure. Angling may further enable sediment to collect at the shoulder of a wine bottle, which may avoid the clogging of the wine extraction mechanism. The angled wine bottle holders (346) may store their respective wine bottles at a 35 degree angle. In one embodiment of the invention, bottle neck sealing cups (348) envelop the mouth of a wine bottle. The bottle neck sealing cups (348) may be used to provide a secondary seal thus preventing leaks from damaging one or more internal components. As suggested above, in one embodiment of the invention, the mechanized multi-cavity needles (350) include functionality to penetrate the wine cork or closure and facilitate the extraction of wine. In one embodiment of the invention, a quick release needle mechanism (352) may be included in the WDD in order to permit the easy removal of the mechanized multi-cavity needles (350) for cleaning.

Turning to FIG. 3C, in another embodiment of the invention, a WDD may include alternative internal components to facilitate the extraction of wine from alternative packaging options, such as wine pouches (366). Examples of these alternative packaging options that may be supported by the WDD may include, but are not limited to, TetraPaks and AstraPouches. In one embodiment of the invention, with the employment of alternative packaging in place of traditional wine bottles, the complexity involved in the design of a WDD is greatly reduced. This is the case because various components associated with the injection of inert gas (e.g., the inert gas canister and inert gas regulator) and/or the solenoids may not be required. Further, a simplified spring-loaded compression disc (360) may substitute the rear bottle securing mechanisms (see e.g., FIG. 3B) employed in the wine bottle design. In one embodiment of the invention, a peristatic pump (362) may alternatively be utilized to extract wine from the alternative packaging. The peristatic pump (362) may include further functionality to measure the volume of wine being dispensed. In one embodiment of the invention, a WDD may include functionality to support and extract wine from wine pouches (366) that envelope 750 milliliters, 1.5 liters, 3 liters, and 6 liters of wine.

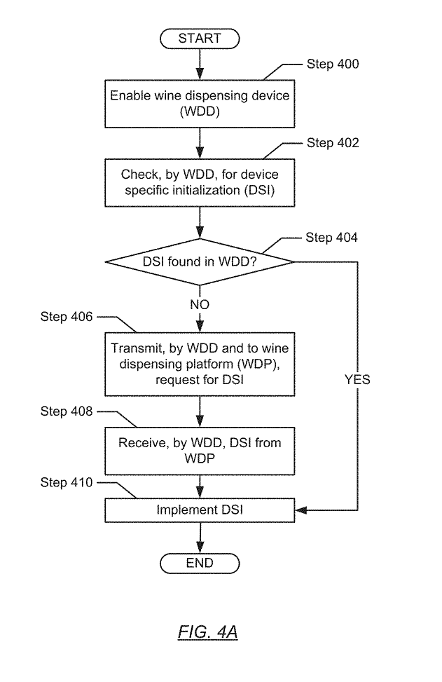

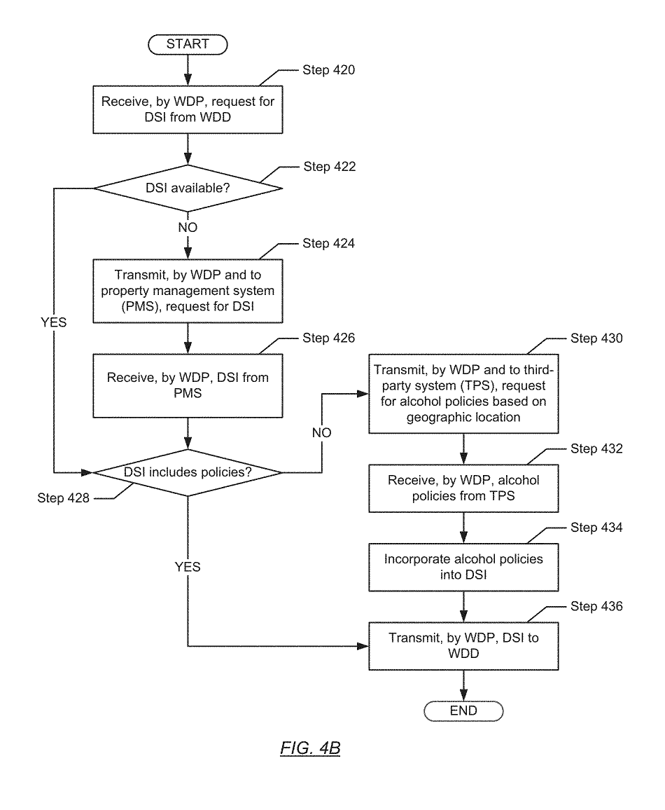

FIGS. 4A-7C show flowcharts in accordance with one or more embodiments of the invention. While the various steps in these flowcharts are presented and described sequentially, one of ordinary skill in the art will appreciate that some or all steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the invention.

FIGS. 4A and 4B show flowcharts describing methods for initializing a wine dispensing device in accordance with one or more embodiments of the invention. More specifically, FIG. 4A describes the aforementioned initialization process from the perspective of the wine dispensing device (WDD), whereas FIG. 4B describes the initialization process from the perspective of the wine dispensing platform (WDP).

Turning to FIG. 4A, in Step 400, a WDD is enabled. In one embodiment of the invention, the WDD may have been recently installed on a property. In another embodiment of the invention, the WDD may have been re-activated after maintenance had been performed. Enablement of the WDD may have encompassed the manual toggling or pushing of a master power switch button on the exterior of the WDD.

In Step 402, checking, by the WDD, for a locally-stored device specific initialization (DSI) is performed. In one embodiment of the invention, the DSI may be an object (e.g., a computer file, a set of software instructions, etc.) that includes the functionality to store default and/or initial parameters and settings for the WDD. In one embodiment of the invention, the DSI may be deposited and accessed from memory (e.g., random access memory (RAM), cache memory, flash memory, etc.) associated with the processing unit. In another embodiment of the invention, the DSI may be stored and retrieved from a non-transitory computer readable medium such as a data repository or storage device (e.g., a file system, database, collection of tables, or any other storage mechanism) embedded within the WDD.

In one embodiment of the invention, the parameters and/or settings provided in the DSI may relate to, for example: (i) the brightness level of the touchscreen; (ii) the time delay specified prior to activation of the touchscreen when an interacting user may be detected by the proximity sensor; (iii) the time duration after which the touchscreen sleeps or powers down; (iv) the volume level through which audio may be projected by the WDD; (v) the customization of messages (e.g., out of order message, service unavailable message, request for service message, etc.) presented through the touchscreen based on various circumstances; (vi) the pour volume measuring a sample or serving of wine; (vii) the local time corresponding to the time zone at which the WDD resides; and (viii) the alcohol-related policies and regulations imposed by the laws of the respective geographic region.

In Step 404, a determination is made as to whether a locally-stored DSI on the WDD has been located. If it is determined that the DSI has not been locally stored, the process proceeds to Step 406. On the other hand, if it is determined that a locally-stored DSI has been found, the process proceeds to Step 410.

In Step 406, in determining that a DSI could not be located locally, a request for the DSI is subsequently generated and transmitted by the WDD to the wine dispensing platform (WDP). In one embodiment of the invention, the request may include a unique device identifier, such as a serial number, which may assist the WDP in identifying the DSI appropriate to the requesting WDD. In another embodiment of the invention, the request may include additional or alternative identifying information, such as the location of the WDD in a local area network (LAN) of the owning property. As such, in one embodiment of the invention, the WDD may include functionality to ascertain its location within the LAN using networking neighbor information and/or detailed information describing the network topology of the LAN.

In Step 408, in response to transmitting the request of Step 406, a DSI is received by the WDD from the WDP. In Step 410, in determining that a locally-stored DSI has been found (Step 404) or after a DSI has been obtained in response to submitting a request (Step 408), the DSI is implemented. In one embodiment of the invention, implementation of the DSI may entail execution of object (e.g., computer file, set of software instructions, etc.) representing the DSI by the processing unit.

Turning to FIG. 4B, from the perspective of the WDP, in Step 420, a request for a DSI is received from a WDD. As discussed above, in one embodiment of the invention, the received request may include a unique identifier or identifying information specific to the WDD.

In Step 422, a determination is made as to whether a DSI for the requesting WDD is available (e.g., locally-stored) in the data repository (see e.g., FIG. 2). Subsequently, if it is determined that the appropriate DSI is unavailable, the process proceeds to Step 424. On the other hand, if it is determined that the appropriate DSI is retrievable from the data repository, then the process proceeds to Step 428.

In Step 424, in determining that the WDP does not retain a locally-stored DSI for the requesting WDD, a request to provide the DSI is transmitted to the property management system (PMS). In one embodiment of the invention, the aforementioned request may include the unique device identifier and/or identifying information pertaining to the WDD. Further, in response to submitting the request, in Step 426, a DSI may be received by the WDP from the PMS. In one embodiment of the invention, a predetermined or default DSI may be provided by the PMS. In another embodiment of the invention, a customized DSI for the requesting WDD may be provided. Furthermore, in one embodiment of the invention, a room identifier (e.g., number, label, etc.) may be provided alongside the DSI, which the WDP may use to maintain a room-device mapping for the WDD.

In Step 428, in determining that a locally-stored DSI is available (Step 422) or after a DSI is obtained in response to a request (Step 426), another determination is made as to whether the DSI includes any restricting instructions pertaining to alcohol-related policies or regulations. If it is determined that the DSI lacks the aforementioned policies and/or regulations, the process proceeds to Step 430. On the other hand, if it is determined that the DSI indeed includes the aforementioned policies and/or regulations, the process proceeds to Step 436.

In Step 430, upon determining that the DSI does not include any restricting instructions pertaining to alcohol-related policies and/or regulations, a request for the pertinent information is generated and transmitted by the WDP and to one or more third-party system(s). In one embodiment of the invention, the WDP may interface with, and obtain alcohol-related policy information from, an alcohol policy information system (APIS). The alcohol-related policies and/or regulations may include detailed information regarding the policies imposed within a geographic locality, which pertains to the sale/purchase of alcohol.

In Step 432, in response to submitting the request of Step 430, alcohol-related policy information is received by the WDP from one or more third-party system(s). In Step 434, restricting instructions are generated and incorporated into the DSI based on the obtained alcohol-related policy and/or regulatory information. In one embodiment of the invention, the restricting instructions, when executed by the processing unit of the WDD, may, for example, instruct the WDD to disable the ability for a guest to purchase or dispense wine during certain days of the week (e.g., Sunday) and/or times of the day (e.g., between 2:00 AM and 11:00 AM). In Step 436, the DSI (including the alcohol policy instructions) is transmitted or pushed towards the requesting WDD.

In one embodiment of the invention, an administrator/user of the PMS may be able to restrict the purchase or dispensing of wine on a given WDD via the platform management subsystem and/or user interface of the WDP. These manual restrictions may be employed in place or in addition to restricting instructions generated based on the obtained alcohol-related policy and/or regulatory information. Further, these manual restrictions may be enforced in the form of drinking hours specified by property specific policies and/or circumstances. These manual restrictions may be specified via any granularity or increment of time (e.g., hours in a day, days in a week, etc.).

FIGS. 5A and 5B show flowcharts describing methods for updating a wine dispensing device in accordance with one or more embodiments of the invention. More specifically, FIG. 5A describes the aforementioned updating process from the perspective of the WDP, whereas FIG. 5B describes the updating process from the perspective of the WDD.

Turning to FIG. 5A, in Step 500, a device specific update (DSU) for a particular room is received by the WDP. In one embodiment of the invention, the DSU may include a unique room identifier (e.g., number, label, etc.) for the particular room and configuration information. In one embodiment of the invention, the configuration information may include, but is not limited to, (i) updated or supplemental configuration parameters and/or settings (e.g., servicing hours (i.e., when the hotel staff may replace used/empty bottle), drinking hours (i.e., when wine may be dispensed from the WDD), serving size, parental lock, etc.); (ii) authorization codes for the comping of specified amounts of wine; (iii) multimedia content and/or information relating to wine, promotions, etc., and (iv) updated alcohol-related policy and/or regulatory information. The DSU may be obtained from the PMS or one or more third-party system(s).

In one embodiment of the technology, step 500 may include generating a set of DSUs for a specific set of WDDs located on the property. For example, a user of the PMS may want to provide complementary wine for all guests attending a wedding. In this example, the PMS may include a code associated with the wedding, where the code is associated with particular room (i.e., rooms in which guests of the wedding at staying). In this scenario, the user, via the PMS, may indicate that each room associated with the particular code associated with the wedding show should two free glasses of wine. In response to this request, the PMS may identify each room that is associated with the particular code and either: (i) send a DSU for each of the identified rooms to the WDP, where the DSU specifies that the identified room is to receive two complementary glasses of wine; or (ii) send a single DSU that includes a list of the identified rooms and an indication that each of the rooms in the lists to receive two complementary glasses of wine.

In Step 502, using room-device mappings, the WDD for which the DSU is intended is identified. In one embodiment of the invention, as discussed above, room-device mappings relate a room on a property to the WDD installed within that room. More specifically, each room-device mapping may include unique identifiers for the room (e.g., number, label, etc.) and the corresponding WDD (e.g., serial number, network address, etc.). Subsequently, in performing a lookup on the available room-device mappings using the room identifier (included in the DSU), the WDP may obtain the associated device identifier, and subsequently determine the WDD for which the DSU is intended.

In one embodiment of the invention, if the DSU received from the PMS includes a list of the identified rooms and information about the configuration to be applied to the WDD in each of the rooms (e.g., each WDD is to provide two complementary glasses of wine to the guests in the room), then prior to step 502, the WDP generates a DSU for each room in the received list. For example, if the DSU received from the PMS lists five room numbers and specifies that each of these rooms is to receive two complementary glasses of wine, then prior to step 502, the WDP generates five DSU, namely, one for each of the rooms specified in the DSU.

In Step 504, the DSU received in Step 500 (with or without the room identifier) is transmitted/pushed towards the WDD identified per the room-device mappings.

Turning to FIG. 5B, from the perspective of the WDD, in Step 520, a DSU is received from the WDP. As discussed above, in one embodiment of the invention, the DSU include computer readable program code relating to: (i) updated or supplemental configuration parameters and/or settings; (ii) authorization codes for the comping of specified amounts of wine; (iii) multimedia content and/or information relating to wine, promotions, etc., and (iv) updated alcohol-related policy and/or regulatory information. In Step 522, the obtained DSU is implemented. Implementation of the DSU may include execution of the aforementioned computer readable program code by the processing unit of the WDD.

In one embodiment of the invention, the PMS may be used to remotely lock and/or disable the WDD. For example, consider a scenario in which the front desk of a hotel has received calls that there is a significant amount of noise coming from room 505. In such scenarios, the user of the PMS be able to obtain real-time wine consumption for room 505 via the platform management module (122) in the PMS. Based on an evaluation of this information, the user of the PMS may then be able to remotely lock the WDD in room 505 via the method described in FIGS. 5A and 5B using a remote locking command.

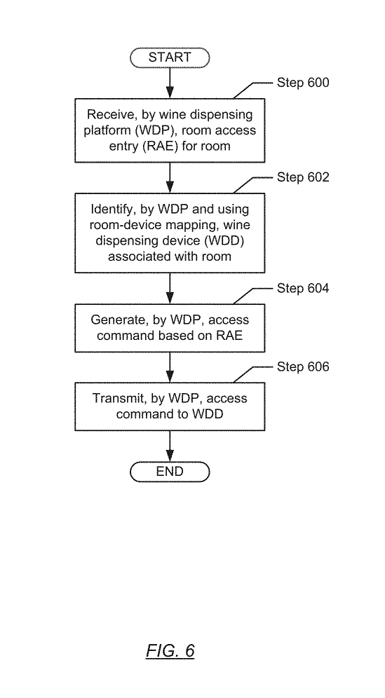

FIG. 6 shows a flowchart describing a method for transmitting an access command in accordance with one or more embodiments of the invention. To that end, in Step 600, a room access entry (RAE) for a particular room is received by the wine dispensing platform (WDP). In one embodiment of the invention, the RAE is obtained by way of the room access management subsystem of the property management system (PMS) (see e.g., FIG. 2) or a similar third-party system. Further, in one embodiment of the invention, the RAE may have been logged in response to the use of an electronic medium (e.g., key card, tag, fob, etc.) to gain access to the room. In one embodiment of the invention, the RAE may include information such as the room identifier associated with the room that was accessed, and a staff or guest specific identifier unique to the staff member or guest to which the electronic medium is encoded.

In Step 602, using room-device mappings, the wine dispensing device (WDD) with which the RAE is associated is identified. Similar to Step 502 in FIG. 5A, in one embodiment of the invention, a lookup of available room-device mappings stored on the WDP may be performed using the room identifier included in the RAE. Subsequently, a device identifier corresponding to the room identifier may be obtained. The device identifier pertains to the WDD that is installed in the room with which the received RAE is associated.

In Step 604, an access command is generated based on the received RAE. More specifically, in one embodiment of the invention, generation of the access command may be based on the staff or guest identifier included in the RAE. Further, the access command may include software instructions corresponding to computer readable program code, which when executed by the processing unit of the WDD, permits or prohibits the WDD to sell and/or dispense wine. In one embodiment of the invention, in response to the RAE including a staff identifier, an access command may be generated instructing the WDD to lock or disable the sale and/or dispensing of wine. By locking the WDD, property staff entering the room are deterred from consuming the wine. In another embodiment of the invention, in response to the RAE including a guest identifier, an access command may be generated instructing the WDD to unlock or enable the sale and/or dispensing of wine. By unlocking the WDD, guests staying in the room may purchase and/or consume the wine. In Step 606, the access command generated in Step 604 is transmitted or pushed to the WDD identified in Step 602.

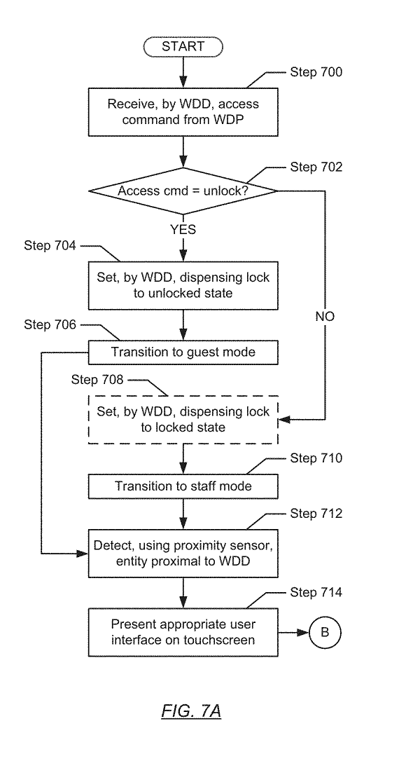

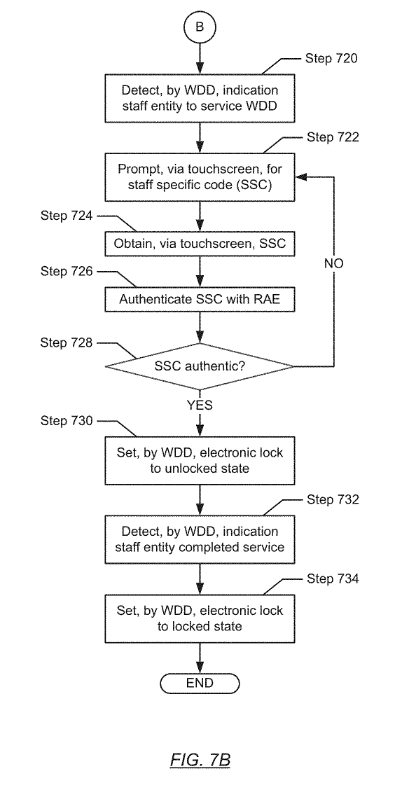

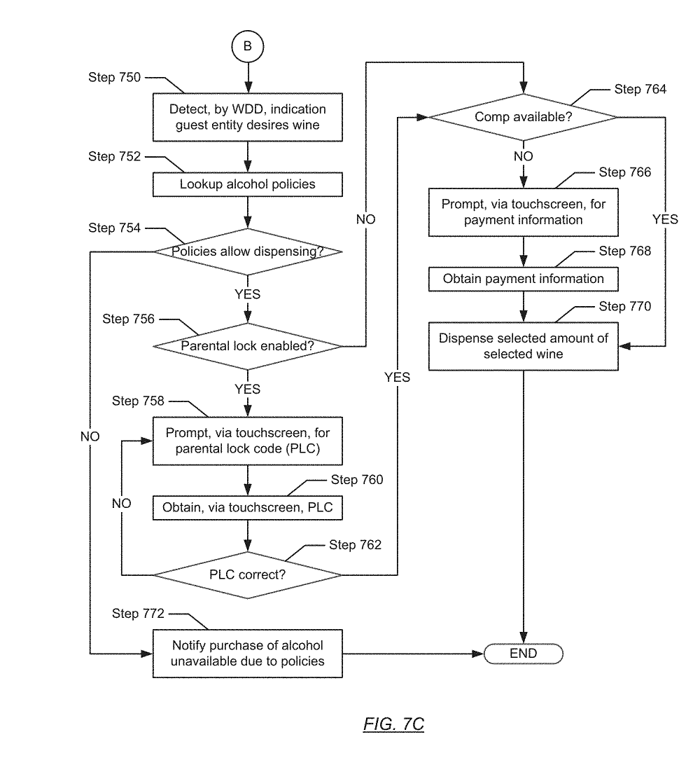

FIG. 7A shows a flowchart describing a method for implementing mode transitioning on a wine dispensing device in accordance with one or more embodiments of the invention. To that end, in Step 700, an access command from the wine dispensing platform (WDP) is received by a wine dispensing device (WDD). In one embodiment of the invention, the access command may include software instruction corresponding to computer readable program code, which when executed by the processing unit of the WDD, permits or prohibits the WDD to sell and/or dispense wine. As discussed above, whether the access command directs the WDD to lock or unlock wine dispensing is dependent on whether property staff or a guest has most recently entered the room.

In Step 702, a determination is made as to whether the access command pertains to unlocking or enabling the sale and/or dispensing of wine. If it is determined that the access command includes instructions to unlock or enable the sale and/or dispensing of wine, the process proceeds to Step 704. On the other hand, if it is determined that the access command includes instructions imposing a restriction to sell and/or dispense wine, the process proceeds to Step 708.

In Step 704, having determined that the access command relates to unlocking the WDD, a dispensing lock at the WDD is set to the unlocked state. In one embodiment of the invention, the dispensing lock may be a logical mechanism which prevents the processing unit of the WDD to obtain wine selection engagement, receive payment method information, and/or access controls for the internal components (e.g., motors, solenoids, etc.) that which facilitate the dispensing of wine. In another embodiment of the invention, guests may unlock the dispensing lock themselves by hovering their issued electronic medium (e.g., key card) over/near an RFID sensor integrated into the WDD.

In Step 706, transitioning of the WDD into guest mode is performed. In one embodiment of the invention, the transition to guest mode may include obtaining or loading, from memory or a storage medium/device, computer readable program code responsible for the instantiation of interactive content and/or controls associated with a guest-appropriate user interface.

In Step 708, having determined that the access command (received in Step 700) relates to locking the WDD, the above-mentioned dispensing lock at the WDD is set to the locked state (granted the dispensing lock was previously set at the unlocked state). In one embodiment of the invention, in the event the dispensing lock had previously been set at the locked state, Step 708 would not be performed and the process would proceed to Step 710. In one embodiment of the invention, the dispensing lock may have maintained an unlocked state prior to a “locking” access command due to a guest entering the room prior to property staff doing so. Conversely, in one embodiment of the invention, the dispensing lock may have maintained a locked state prior to a “locking” access command due to the absence of an individual in the room, of which the proximity sensor of the WDD may have otherwise detected. The absence of an individual or detectable motion within the room may be interpreted as (i) the room is vacant/available, or (ii) guests paying for and/or occupying the room are not in the room presently.

In Step 710, transitioning of the WDD into staff mode is performed. In one embodiment of the invention, the transition to staff mode may include obtaining or loading, from memory or a storage medium/device, computer readable program code responsible for the instantiation of interactive content and/or controls associated with a staff-appropriate user interface.

In Step 712, the WDD then waits until its proximity sensor detects an entity proximal to the WDD. Upon detection of an individual in the room, in Step 714, the guest-appropriate user interface (loaded in Step 706) or the staff-appropriate user interface (loaded in Step 710) is presented via the touchscreen to the staff member or guest, respectively.

FIGS. 7B and 7C show flowcharts describing methods for interacting with an entity in accordance with one or more embodiments of the invention. More specifically, FIG. 7B describes the interactivity between a WDD and property staff entities, whereas FIG. 7C describes the interactivity between a WDD and guest entities.

Turning to FIG. 7B, in Step 720, an indication informing that an interacting staff user is to service or perform maintenance on the WDD is detected. In one embodiment of the invention, the indication may include detection via the touchscreen that the interacting staff user has selected or engaged with interactive controls corresponding to the disablement of the electronic lock. In one embodiment of the invention, the electronic lock may be an electronically controlled and monitored locking device that permits or prohibits access to the interior of the WDD.

In Step 722, in response to the indication detected in Step 720, entry of a staff specific code (SSC) is prompted via the touchscreen. In one embodiment of the invention, the SSC may be an authorization code in the form of a sequence of numbers of any specified length. In one embodiment of the invention, the SSC may be a master authorization code utilized by all property staff. In another embodiment of the invention, the SSC may be a unique authorization code assigned to each staff member.

In Step 724, an SSC is obtained through the touchscreen. Subsequently, in Step 726, the obtained SSC is compared against information included in the most recent room access entry (RAE) logged for the room in which the WDD is installed. More specifically, in one embodiment of the invention, the SSC may be compared against the staff identifier included in the most recent RAE. In one embodiment of the invention, the comparison may be performed in order to authenticate or verify the obtained SSC.

In Step 728, a determination is made as to whether the obtained SSC is authentic. If it is determined that the obtained SSC is authentic, the process proceeds to Step 730. On the other hand, if it is determined that the obtained SSC is incorrect or has been mistyped, the process reverts back to Step 722 and re-prompts the interacting staff user for a proper SSC.

In Step 730, in determining that the SSC (obtained in Step 724) is authentic, the electronic lock controlling access to the interior of the WDD is set to the unlocked state. From here, the interacting staff user may engage with the interior components of the WDD for servicing and/or maintenance purposes. Examples of the activities performed by the interacting staff user may include, but are not limited to: (i) the replacement of an empty or near empty wine bottle or pouch with a full wine bottle or pouch; (ii) the refilling of the cleaning reservoir with cleaning solution; (iii) the replacement of an empty or near empty inert gas canister with a full inert gas canister; (iv) the replacement of a malfunctioning solenoid, motor, flow meter, or any other component of the WDD (see e.g., FIGS. 3A-3C); and (v) the replacement of a leaking bottle neck sealing cup with a new bottle neck sealing cup. Each of the aforementioned activities may be logged by the WDD.

In Step 732, an indication informing that the interacting staff user has completed servicing or performing maintenance on the WDD is detected. In one embodiment of the invention, the indication may include detection via the touchscreen that the interacting staff user has selected or engaged with interactive controls corresponding to the enablement of the electronic lock. Subsequently, in Step 734, in response to the indication detected in Step 732, the electronic lock controlling access to the interior of the WDD is set to the locked state.

Turning to FIG. 7C, when engaged by an interacting guest user, in Step 750, an indication informing that the interacting guest user wishes to purchase and/or dispense wine is detected. In one embodiment of the invention, the indication may include detection via the touchscreen that the interacting guest user has selected or engaged with interactive controls tethered to the actuation of the solenoids and/or motors to facilitate the pouring of a selected wine.

In Step 752, a lookup of the alcohol-related policies and/or regulations for the geographic locality in which the WDD resides is performed. In one embodiment of the invention, the aforementioned policies and/or regulations may already have been stored in, and available to retrieve from, associated memory or a storing medium/device of the WDD. In another embodiment of the invention, the WDD may generate and transmit a request for the alcohol-related policy and/or regulatory information to the wine dispensing platform (WDP). In one embodiment of the invention, the alcohol-related policies and/or regulations may be associated with software instructions corresponding to computer readable program code, which when executed by the processing unit, permit or prohibit the sale and/or dispensing of wine based on, for example, the day of the week or the time of the day.

In Step 754, a determination is made as to whether the sale and/or dispensing of wine is allowed in accordance with the geographic locality-based alcohol-related policies and/or regulations. If it is determined that the sale and/or dispensing of wine is permitted, the process proceeds to Step 756. On the other hand, if it is determined that the sale and/or dispensing of wine is prohibited, the process proceeds to Step 772.

In Step 756, upon determining that the sale and/or dispensing of wine has been permitted, another determination is made as to whether a parental lock is enabled. In one embodiment of the invention, a parental lock may be a logical locking mechanism imposed to inhibit/prevent the consumption of wine by underage guests. The WDD may be programmed with a parental lock using, for example, the methods shown in FIGS. 5A and 5B. Subsequently, if it is determined that a parental lock has been instantiated, the process proceeds to Step 758. On the other hand, if it is determined that a parental lock has not been employed, the process proceeds to Step 764.

In Step 758, upon determining that a parental lock has been enabled, the interacting guest user is prompted via the touchscreen for the parental lock code (PLC). In one embodiment of the invention, the PLC may be an authorization code in the form of a sequence of numbers of any specified length. In one embodiment of the invention, the PLC may have been selected by an adult guest occupying the room. In another embodiment of the invention, the PLC may have been generated by a staff member or the property management system (PMS) during the check-in process at the property.

In Step 760, the PLC is obtained via the touchscreen. Subsequently, in Step 762, another determination is made as to whether the obtained PLC is correct. In one embodiment of the invention, the obtained PLC may be compared to the correct PLC, which may be stored in associated memory or a storage medium/device in the wine dispensing device (WDD). Further to the comparison, if it is determined that the obtained PLC matches the correct PLC, the process proceeds to Step 764. On the other hand, if it is determined that the obtained PLC does not match the correct PLC, the process reverts to Step 758, whereupon the interacting guest user is re-prompted for the PLC.

In Step 764, having determined that the parental lock has not been employed (Step 756) or the obtained PLC matches the correct PLC (Step 762), another determination is made as to whether a comp or a free pour of wine is available. In one embodiment of the invention, free or comped pours may be awarded to a guest for a variety of reasons. Examples of these reasons include, but are not limited to: the turning around of a negative guest experience (e.g., malfunctioning room amenity that cannot be serviced immediately); the accumulation of property-affiliated rewards or loyalty program points; and the use of a promotional code, coupon, or voucher by the guest during the room reservation process. In view of this, if it is determined that a free pour of wine is available, the process proceeds to Step 770. On the other hand, if it is determined that the option for comped wine is unavailable, then the process proceeds to Step 766.

In Step 766, having determined that free pours of wine are unavailable, the interacting guest user is prompted via the touchscreen for payment-related information. In Step 768, the payment-related information is obtained. In one embodiment of the invention, the payment-related information may be obtained through the manual entering of information using the user interface. In another embodiment of the invention, the payment-related information may be obtained through transfer of the information using any wireless communication protocol (e.g., Bluetooth, near-field communication (NPC), etc.) established between a mobile computing system owned by the interacting guest user and the WDD. In yet another embodiment of the invention, the payment-related information may be obtained through the capturing and interpreting of, for example, credit card information by the front-facing camera of the WDD.

In Step 770, after confirming payment for the desired wine or determining that wine comps or free pours are available, the selected volume of the selected wine is dispensed. In one embodiment of the invention, the dispensing of the wine may be further facilitated or hindered based on whether a container (e.g., glass, mug, cup, etc.) is detected, by the proximity sensor, under the pouring spout associated with the selected wine.

In Step 772, after determining that the sale and/or dispensing of wine has been prohibited in accordance with the local alcohol-related policies and/or regulations (Step 754), the interacting guest user is notified via the user interface that the purchase and/or pouring of wine is unavailable.

Those skilled in the art will appreciated that while the above invention has been described with respect to wine, embodiments of the invention may be used for dispensing other liquids including but not limited to, liquor, champagne, beer, and non-alcoholic beverages.

Embodiments of the invention may be implemented on a computing system. Any combination of mobile, desktop, server, router, switch, embedded device, or other types of hardware may be used. For example, as shown in FIG. 8A, the computing system (800) may include one or more computer processors (802), non-persistent storage (804) (e.g., volatile memory, such as random access memory (RAM), cache memory), persistent storage (806) (e.g., a hard disk, an optical drive such as a compact disk (CD) drive or digital versatile disk (DVD) drive, a flash memory, etc.), a communication interface (812) (e.g., Bluetooth interface, infrared interface, network interface, optical interface, etc.), and numerous other elements and functionalities.

The computer processor(s) (802) may be an integrated circuit for processing instructions. For example, the computer processor(s) may be one or more cores or micro-cores of a processor. The computing system 4) may also include one or more input devices (810), such as a touchscreen, keyboard, mouse, microphone, touchpad, electronic pen, or any other type of input device.

The communication interface (812) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the computing system (800) may include one or more output devices (808), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (802), non-persistent storage (804), and persistent storage (806). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (800) in FIG. 8A may be connected to or be a part of a network. For example, as shown in FIG. 8B, the network (820) may include multiple nodes (e.g., node X (822), node Y (824)). Each node may correspond to a computing system, such as the computing system shown in FIG. 8A, or a group of nodes combined may correspond to the computing system shown in FIG. 8A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (800) may be located at a remote location and connected to the other elements over a network.

Although not shown in FIG. 8B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (822), node Y (824)) in the network (820) may be configured to provide services for a client device (826). For example, the nodes may be part of a cloud computing system. The nodes may include functionality to receive requests from the client device (826) and transmit responses to the client device (826). The client device (826) may be a computing system, such as the computing system shown in FIG. 8A. Further, the client device (826) may include and/or perform all or a portion of one or more embodiments of the invention.

The computing system or group of computing systems described in FIG. 8A and 8B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the GUI by a user selecting one or more GUI widgets or inserting text and other data into GUI widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 8A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 8A, while performing one or more embodiments of the invention, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 8A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 8A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 8A and the nodes and/or client device in FIG. 8B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for regulating wine dispensing, comprising:
receiving a device specific update (DSU), wherein the DSU specifies at least one location and configuration information;
identifying a wine dispensing device (WDD) associated with the at least one specified location; and
transmitting the DSU to the WDD.

2. The method of claim 1, further comprising:
receiving status information from at least the WDD.

3. The method of claim 2, wherein the status information comprises real-time information about the at least one WDD.

4. The method of claim 3, wherein the real-time information comprises wine levels in the at least one WDD.

5. The method of claim 2, wherein the status information comprises near real-time information about the at least one WDD.

6. The method of claim 5, wherein the near real-time information comprises wine levels in the at least one WDD.

7. The method of claim 2, further comprising:
after receiving the status information, generating a service list, wherein the service list only specifies WDDs that have a wine level below a threshold wine level.

8. The method of claim 7, wherein generating the service list comprises using a consumption rate of at least one WDD.

9. The method of claim 1, wherein the configuration information specifies at least one alcohol-related policy.

10. The method of claim 9, wherein the at least one alcohol-related policy specifies drinking hours.

11. The method of claim 9, wherein the at least one alcohol-related policy specifies service hours.

12. The method of claim 1, wherein the configuration information a message to be displayed to a user when a touchscreen of the WDD is activated.

13. The method of claim 1, wherein the configuration information specifies at least one parental lock code.

14. The method of claim 1, wherein the configuration information specifies a number of complementary glasses of wine to dispense to a user of the WDD.

15. The method of claim 1, wherein the location is a room.

16. The method of claim 1, wherein the DSU specifies a plurality of locations.

17-25 (canceled)

26. A non-transitory computer readable medium (CRM) storing instructions for regulating wine dispensing, the instructions comprising functionality for:
receiving a device specific update (DSU), wherein the DSU specifies at least one location and configuration information;
identifying a wine dispensing device (WDD) associated with the at least one specified location; and
transmitting the DSU to the WDD.

27. The CRM of claim 26, the instructions comprising further functionality for:
receiving status information from at least the WDD.

28. The CRM of claim 27, wherein the status information comprises real-time information about the at least one WDD.

29. The CRM of claim 28, wherein the real-time information comprises wine levels in the at least one WDD.

30-41. (canceled)
